(19) United States
(12) Patent Application Publication
(10) Pub. No.: US 2012/0158579 A1
(43) Pub. Date: Jun. 21, 2012

(54) SYSTEM AND METHOD FOR CREATING AND MAINTAINING INVESTOR COMMUNITY NETWORK

(75) Inventors: Sasa MARINIC, Zeewolde (NL); Paul O'CONNOR, Hoevelaken (NL)

(73) Assignee: ANTECY B.V., Hoevelaken (NL)

(21) Appl. No.: 13/304,430

(22) Filed: Nov. 25, 2011

Related U.S. Application Data
(60) Provisional application No. 61/416,754, filed on Nov. 24, 2010.

(51) Int. Cl. G06Q 40/00

(52) U.S. Cl. 705/39

(57) ABSTRACT

A system is disclosed for raising investment funding of an enterprise.

The system comprises social network or a dedicated space on an internet-based social network; a payment system interactively connected to the social network; and a certificate holder database interactively connected to the social network.

The system allows raising investment funding from a large number of small investors, without creating an unduly large administrative burden.

The social network provides a platform for the exchange of ideas and opinions that are relevant to the course and the business of the enterprise.

### CROSS REFERENCE TO RELATED APPLICATIONS

This application is a non-provisional application of U.S. provisional application No. 61/416,754 filed on 24 Nov. 2010, which application is hereby incorporated by reference in its entirety.

### BACKGROUND OF THE INVENTION

1. Field of the Invention

The invention relates generally to a system for creating and maintaining an investor community network, and more particularly to a system for creating a large network of small individual investors.

2. Description of the Related Art

Corporations seeking funding by selling shares of its stock must comply with a number of legal and regulatory requirements. As a minimum such corporations must maintain a record of legal and natural persons that have made an investment. Corporations must provide their shareholders with regular updates on their financial wellbeing; they must schedule regular shareholder meetings and, depending on the type of shares held by their shareholders, must arrange for shareholders to be allowed to vote at such shareholder meetings.

Because of these and other requirements corporations engage in costly administrative procedures, designed to ensure legal and regulatory compliance.

Another drawback of the investment systems of the prior art is that shares of stock are typically sold through stock exchanges, requiring the use of a stock broker for acquiring stocks in a specific corporation. Although the advent of internet trading has lowered the fees charged by stock brokers, the need to pay such fees encourages the purchase of corporate shares in sizable blocks, as opposed to single shares or small bundles of shares. Corporations also favor the sale of large blocks of shares, as it simplifies and lightens their administrative burden.

For these and other reasons, equity investing is to a large extent in the hands of institutional investors, such as investment banks and pension funds. Individual investors typically make their investments through mutual funds. However, mutual fund investing creates another cost for the individual investor, as these funds carry considerable overhead for administration and financial analysis. Fund investing also creates a distance between the investors and the corporations in which they have invested their money.

There is a growing desire on the part of individual investors to gain control of the allocation of their investments. For example, investors may choose to invest in corporations that engage in fair trade, that engage in sustainable production and distribution methods, that conduct research on methods for sustainable producing energy, and the like. In addition, there is a growing desire on the part of motivated investors to engage in a dialogue with the corporations in which they invest, and with fellow investors.

At the same time there is a need for corporations to lower the threshold for individual investors to acquire shares of their stock, while at the same time remaining in full compliance with the relevant legal and regulatory requirements. There is a further need for corporations to tap into the investment funds of a large number of small individual investors without creating an overly costly administrative burden.

### BRIEF SUMMARY OF THE INVENTION

The present invention addresses these problems by providing a system for raising investment funding of an enterprise, said system comprising:
a dedicated space on an internet-based social network;
a payment service interactively connected to the social network;
a certificate holder database interactively connected to the social network.

Another aspect of the invention comprises a method for raising investment funding from a large community of small investors, said method comprising the steps of:
receiving payment from an investor;
receiving investor information from the investor uniquely identifying the investor;
using the investor information, creating or updating an investor profile in a certificate holder database;
issuing a uniquely identified shareholder certificate in the name of the investor.

### BRIEF DESCRIPTION OF THE DRAWINGS

The features and advantages of the invention will be appreciated upon reference to the following drawings, in which:

FIG. 1 is a schematic representation of an embodiment of the system of the invention.

### DESCRIPTION OF ILLUSTRATIVE EMBODIMENTS

The following is a description of certain embodiments of the invention, given by way of example only and with reference to the drawing.

The block labeled “Social Network” can be a social network specifically created for the system of the invention, or it can be a dedicated space on an internet social network provided by a third party.

A social network, as this term is used herein, is web-based an online service, platform, or site that focuses on building and reflecting of social relations among individuals who share specific interests. A social network service comprises a profile, his/her social links, and a variety of additional services.

The main types of social networking services are those which contain category places (such as former school-year or classmates), means to connect with friends (usually with self-description pages) and a recommendation system linked to trust. Popular methods now combine many of these with general networks having millions of members. Examples include Facebook; Twitter; MySpace; LinkedIn; Nexopia; Bebo; Hi5; Hyves; StudiVZ; iWiW; Tuenti; Nasza-Klasa; Tagged; XING; Badoo; Skyrock; Orkut; Friendster; Mixi; Multiply; Wretch; renren; and Cyworld.

The block labeled “Payment Service” represents in internet based secure payment system. Examples include systems covered under the Automated Clearing House (ACH), as used in the US. Specific examples include PayPal; DigiCash; CyberCash; SET; Mondex; and Open Market.

The block labeled “Members” is a schematic representation of a community of individual investors.

The block labeled “Database and Administration” is a schematic representation of the administrative services that are provided within the system.

The block labeled “Antecy” is a schematic representation of an enterprise. In the depicted embodiment the database and administrative services are provided by a separate entity. It will be understood that, in an alternate embodiment, these services may be handled by the corporation itself.

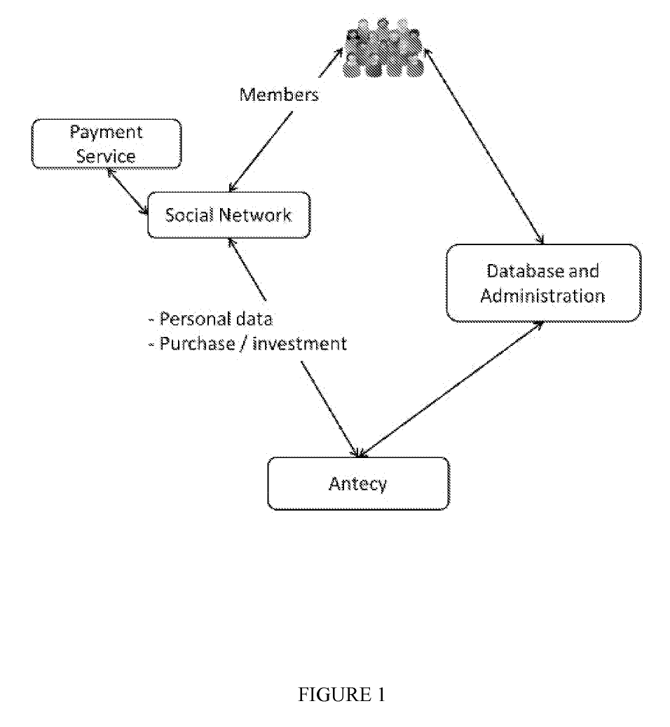

The system depicted in FIG. 1 can be used in a number of different ways. For example, it can be used to set up an investor profile for a new investor; for updating an investor profile for an existing investor; for issuing shareholder certificates to a new investor; for issuing additional shareholder certificates to an existing investor; for trading shareholder certificates; for the corporation to provide information to the shareholder community; for the corporation to provide information to a subset of shareholders; for the shareholder community to engage in intra-community transfer of share certificates; for the shareholder community to engage in an exchange of opinions and ideas; for the shareholder community to influence business decisions of the corporation; for conducting shareholder meetings; for formal shareholder voting; and the like.

The use of the system will be illustrated with reference to a number of specific examples.

### EXAMPLE 1

### Creating a New Investor Profile and Issuance of Share Certificates

A prospective new investor is connected to the website of the corporation. The website contains interactive means, such as a button in a dialogue box, a link, or some other such means, allowing the prospective investor to express an interest in purchasing shares of stock in the corporation.

When the prospective investor indicates an interest in making an investment, he/she is connected to an interactive form, asking the investor to provide specific information such as the number of shares the investor desires to purchase; payment method; payment details; individual details, for example name, age, social security number, and the like; contact details, such as place of residence and e-mail address; and any other personal information as may be required by law.

The information is communicated to the Database and Administration, either directly or indirectly, for example via the corporation. Database and Administration uses the provided information to create an investor profile, which is kept in a shareholder database.

As part of the transaction the Payment Service certifies the financial aspects of the share purchase, and ensures payment into a special account. Upon confirmation received from the Payment Service, Database and Administration generates uniquely identified share certificates and provides the certificates with an electronic signature. Facsimile copies of the share certificates, for example in PDF format, are sent to the e-mail address provided by the investor. The unique identification of the share certificates can be in any form, for example alpha numeric serial numbers. The certificate identifiers are included in the investor's profile in the shareholder database.

Concurrent with this transaction the shareholder can be provided with login data, for example a username and an associated password, allowing the shareholder access to the Social Network.

### EXAMPLE 2

### Updating an Investor Profile

Any time there is a change in an essential part of the investor's profile, the investor can gain access to his or her profile, using the investor's login data. The investor provides an online update of the profile, which is scrutinized by the Database and Administration service for apparent errors. Database and Administration also sends a confirmation message to the investor's e-mail address, confirming the profile change and allowing the investor to take remedial action if the profile change contains an error or was made without authorization.

A specific example of a profile change is when the investor purchases additional shares of stock. In this case the Payment Service handles the financial aspects of the transaction, and issues a confirmation to Database and Administration. The latter then issues share certificates, as described in Example 1.

### EXAMPLE 1

### Intra-community Share Transfers

Members of the shareholder community can communicate with each other using the Social Network. They can use this ability in a number of ways related to their shared interest in the corporation and its social profile. In a specific example shareholders can trade shares with fellow members of the shareholder community. In a non-limiting example such transaction can be conducted as follows.

A shareholder wishing to share some or all of his/her shares uses the Social Network to identify fellow-shareholders interested in buying additional shares. The parties then negotiate a transfer price in a private setting, for example by telephone, by exchanging e-mail messages, or using a dedicated private communication channel on the Social Network.

When agreement has been reached on the details of the transaction, the two parties to the transaction each provide specific details to the Payment Service. For example, the seller provides the serial numbers of the certificates being sold, and the agreed transfer price. The buyer confirms the transfer price, and provides payment details. Database and Administration receives confirmation of the transaction from Payment Services, and updates the respective shareholder profiles accordingly.

### EXAMPLE 4

### Transfer of Shares to a New Investor

In this example an investor wishing to sell some or all of his/her shares finds a willing buyer outside the member community. The new investor sets up a new investor profile, as described in Example 1. Instead of buying shares directly from the corporation, the new investor indicates in his/her profile that he/she will be buying shares from an existing investor. Once a profile is created for the new investor the transaction proceeds as described in Example 3.

### EXAMPLE 5

### Use of the Social Network

The Social Network provides a tool for shareholder communication. Individual shareholders can express concern with certain steps that the corporation is taking. Other shareholders may respond and reassure the shareholders that have raised the concerns. If the concerns persist the corporation can use the Social Network to provide necessary background for its decisions.

The corporation can use the Social Network to gauge opinions within its shareholder community. For example, the corporation is considering two mutually exclusive courses of action. It can use its cash on hand to acquire another company, or it can use its financial position to increase its R&D investment. By generating a discussion on the Social Network the corporation can establish whether its shareholder community has a strong preference for one of the alternatives.

### EXAMPLE 6

### Making a Gift of Stock Certificates

The system can be set up to permit one investor, the donor, to make a gift of stock certificates to another investor, the donee. If the donor already owns the shares of stock he or she wishes to donate, and the donee already has an investor profile in the system, the transaction is similar to that of example 3. The main difference is that the donee does not pay for the share certificates.

If the donor already owns the shares of stock he or she wishes to donate, and the donee does not yet have an investor profile in the system, the transaction is similar to that of example 4, the main difference being that the donee does not pay for the shares of stock.

In case the donor does not yet own the shares of stock he or she wishes to donate, the process of the transaction can be as follows:

If the donee does not yet have an investor profile in the system, the donee creates a profile as described in Example 1; the profile specifies that the investor will receive stock certificates from another investor;

The donor sets up an investor profile, and makes a purchase of shares of stock, specifying that the stock certificates should be issued in the name of the donee.

In a preferred embodiment the system rewards the donor by giving the donor access to the Social Network, even though the donor is not an investor. This gesture of goodwill increases the chance that the donor may in the future make an investment in his or her own name. In this embodiment the investor profile reflects the fact that the investor does not own stock certificates, to ensure that the donor will not receive mailings intended for investors only.

Thus, the system provides an enterprise with a means for raising investments from a large number of small investors, while minimizing the administrative costs.

The system also provides an enterprise with a means for increasing shareholder interest and shareholder participation, thereby expanding its shareholder base and improving shareholder loyalty.

1. A system for raising investment funding of an enterprise, said system comprising:
a. a dedicated space on an internet-based social network;
b. a payment service interactively connected to the social network;
c. a certificate holder database interactively connected to the social network.

2. The system of claim 1 wherein a certificate holder or prospective certificate holder provides input into the certificate holder database.

3. The system of claim 2 wherein the input from a prospective certificate holder is entered into the certificate holder database upon receipt by a database controller of a verification signal generated by the payment service.

4. The system of claim 1 wherein the enterprise communicates with certificate holders via the dedicated space on the social network.

5. The system of claim 1 wherein certificate holders communicate with each other via the dedicated space on the social network.

6. The system of claim 1 wherein the enterprise complies with regulatory certificate holder communications using the dedicated space on the social network.

7. The system of claim 1 wherein the enterprise generates ideas from certificate holders using the dedicated space on the social network.
